(19) United States
(12) Patent Application Publication
(10) Pub. No.: US 2024/0340724 A1
(43) Pub. Date: Oct. 10, 2024

(54) Radio Link Failure Report Enhancements for Handover Failure

(71) Applicant: Telefonaktiebolaget LM Ericsson (publ), Stockholm (SE)

(72) Inventors: Pradeepa Ramachandra, Linköping (SE); Antonino Orsino, Kirkkonummi (FI); Marco Belleschi, Solna (SE)

(21) Appl. No.: 18/692,473

(22) PCT Filed: Sep. 15, 2022
(86) PCT No.: PCT/SE2022/050813

§ 371 Date: Mar. 15, 2024

Related U.S. Application Data
(60) Provisional application No. 63/245,518, filed on Sep. 17, 2021.

(51) Int. Cl. H04W 36/00; H04W 24/04; H04W 74/0808

(52) U.S. Cl. CPC H04W 36/0079; H04W 24/04; H04W 74/0808

(57) ABSTRACT

A method in a wireless device for reporting handover failure, HOF, in a wireless network comprises the steps of deter mining (210) that a HOF has occurred in connection with a reconfiguration of at least one connection of the wireless device to the wire less network and sending (220), to the wireless network, one or more messages reporting the HOF, the one or more messages comprising one or both of an indication of at least one listen-before-talk, LBT, failure experienced by the wireless device in connection with the reconfiguration or an indication of a random access problem experienced by the wireless device in connection with the reconfiguration.

### TECHNICAL FIELD

The present disclosure is generally related to wireless networks and is more particularly related to reporting information related to handover failures in such wireless networks.

### BACKGROUND

The Self-Organizing Network (SON) is an automation technology designed to make the planning, configuration, management, optimization, and healing of mobile radio access networks simpler and faster. SON functionality and behavior has been defined and specified in generally accepted mobile industry recommendations produced by organizations such as 3GPP (3rd Generation Partnership Project) and the NGMN (Next Generation Mobile Networks).

In 3GPP, processes within the SON area are classified into self-configuration processes and self-optimization processes. Self-configuration processes are where newly deployed nodes are configured by automatic installation procedures to get the necessary basic configuration for system operation. The self-configuration processes work in the pre-operational state, where the pre-operational state is understood as the state from when the eNB (or other base station) is powered up and has backbone connectivity until the radio frequency (RF) transmitter is switched on. As illustrated in FIG. 1, which generally illustrates the ramifications of self-configuration and self-optimization functionality, and which is taken from 3GPP TS 36.300 FIGS. 22.1-1, functions handled in the pre-operational state like:
Basic Setup; and
Initial Radio Configuration. are covered by the self-configuration processes.

Self-optimization processes are defined as processes where UE (wireless terminal) and access node measurements and performance measurements are used to auto-tune the network. These processes work in the operational state, where the operational state is understood as the state where the RF interface of the base station(s) is additionally switched on. As shown in FIG. 1, functions handled in the operational state like:
OptimizationlAdaptation are covered by the self-optimization processes.

In LTE, support for self-configuration and self-optimization is specified, as described in 3GPP TS 36.300 section 22.2, including features such as dynamic configuration, automatic neighbor relation (ANR), mobility load balancing, mobility robustness optimization (MRO), RACH optimization, and support for energy saving. In NR, support for self-configuration and self-optimization is specified as well, starting with self-configuration features such as dynamic configuration, automatic neighbor relation (ANR) in Rel-15, as described in 3GPP TS 38.300 section 15. In NR Rel-16, more SON features are being specified, including self-optimization features such as mobility robustness optimization (MRO).

Seamless handovers are a key feature of 3GPP technologies. Successful handovers ensure that the UE moves around in the coverage area of different cells without causing excessive interruptions in data transmission. However, there will be scenarios when the network fails to handover the UE to the ‘correct’ neighbor cell in time and in such scenarios the UE will declare radio link failure (RLF) or Handover Failure (HOF).

Upon HOF and RLF, the UE may take various autonomous actions, such as trying to select a cell and initiate reestablishment procedure to ensure that the UE reestablishes connectivity as soon as it can, so that it can be reachable again. An RLF will cause a poor user experience, as the RLF is declared by the UE only when it realizes that there is no reliable communication channel (radio link) available between itself and the network. Also, reestablishing the connection requires signaling with the newly selected cell (random access procedure, RRC Reestablishment Request, RRC Reestablishment RRC Reestablishment Complete, RRC Reconfiguration and RRC Reconfiguration Complete) and adds some latency before the UE can exchange data with the network again.

According to 3GPP specifications (3GPP TS 36.331), possible causes for radio link failure could be one of the following:
1) Expiry of the radio link monitoring related timer T310;
2) Expiry of the measurement reporting associated timer T312 (not receiving the handover command from the network within this timer's duration despite sending the measurement report when T310 was running);
3) Upon reaching the maximum number of RLC retransmissions;
4) Upon receiving random access problem indication from the MAC entity.

As RLF leads to reestablishment which degrades performance and user experience, it is in the interest of the network to understand the reasons for RLF and try to optimize mobility related parameters (e.g., trigger conditions of measurement reports) to avoid later RLFs. Before the standardization of MRO related report handling in the network, only the UE was aware of information such as how the radio quality looked like at the time of RLF, what was the actual reason for declaring RLF, etc. For the network to identify the reason for the RLF, the network needs more information, both from the UE and from neighboring base stations.

As part of the MRO solution in LTE, an RLF reporting procedure was introduced in the RRC specification in Rel-9 RAN2 work. That impacted the RRC specifications (TS 36.331) in the sense that it was standardized that the UE would log relevant information at the moment of an RLF and later report to a target cell to which the UE successfully connected (e.g., after reestablishment). That has also impacted the inter-gNodeB interface, i.e., X2AP specifications (3GPP TS 36.423), since an eNodeB receiving an RLF report could forward the report to the eNodeB where the failure originated.

The contents of the RLF report generated by the UE have been enhanced with more details in the subsequent releases of the specifications. The measurements included in the measurement report based on the latest LTE RRC specification are:
1) Measurement quantities (RSRP, RSRQ) of the last serving cell (PCell).
2) Measurement quantities of the neighbor cells in different frequencies of different RATs (EUTRA, UTRA, GERAN, CDMA2000).
3) Measurement quantity (RSSI) associated to WLAN Aps.
4) Measurement quantity (RSSI) associated to Bluetooth beacons.
5) Location information, if available (including location coordinates and velocity)
6) Globally unique identity of the last serving cell, if available, otherwise the PCI and the carrier frequency of the last serving cell.
7) Tracking area code of the PCell.
8) Time elapsed since the last reception of the ‘Handover command’ message.
9) C-RNTI used in the previous serving cell.
10) Whether or not the UE was configured with a DRB having QCI value of 1.

After an RLF is declared, the RLF report is logged by the UE and included in the VarRLF-Report. Once the UE selects a cell and succeeds with a reestablishment, the UE includes an indication that it has an RLF report available in the RRC Reestablishment Complete message, to make the target cell aware of that availability. Then, upon receiving an UEInformationRequest message with a flag “rlf-ReportReq-r9,” the UE includes the RLF report (stored in a UE variable VarRLF-Report, as described above) in an UEInformationResponse message and sends it to the network.

Based on the RLF report from the UE and the knowledge about the cell with which the UE reestablished itself, the original source cell can deduce whether the RLF was caused by a coverage hole or by handover-associated parameter configurations. If the RLF was deemed to be due to handover-associated parameter configurations, the original serving cell can further classify the handover related failure as too-early, too-late or handover to wrong cell classes. These handover failure classes are explained in brief below:
1) Whether the handover failure occurred due to the ‘too-late handover’ cases:
   a. The original serving cell can classify a handover failure to be ‘too late handover’ when the original serving cell fails to send the handover command to the UE associated to a handover towards a particular target cell and if the UE reestablishes itself in this target cell post RLF.
   b. An example corrective action from the original serving cell could be to initiate the handover procedure towards this target cell a bit earlier by decreasing the CIO (cell individual offset) towards the target cell that controls when the IE sends the event triggered measurement report that leads to taking the handover decision.
2) Whether the handover failure occurred due to the ‘too-early handover’ cases:
   a. The original serving cell can classify a handover failure to be ‘too early handover’ when the original serving cell is successful in sending the handover command to the UE associated to a handover however the UE fails to perform the random access towards this target cell.
   b. An example corrective action from the original serving cell could be to initiate the handover procedure towards this target cell a bit later by increasing the CIO (cell individual offset) towards the target cell that controls when the IE sends the event triggered measurement report that leads to taking the handover decision.
3) Whether the handover failure occurred due to the ‘handover-to-wrong-cell’ cases:
   a. The original serving cell can classify a handover failure to be ‘handover-to-wrong-cell’ when the original serving cell intends to perform the handover for this UE towards a particular target cell but the UE declares the RLF and reestablishes itself in a third cell.
   b. A corrective action from the original serving cell can be to initiate the measurement reporting procedure that leads to handover towards the target cell a bit later, by decreasing the CIO (cell individual offset) towards the target cell or via initiating the handover towards the cell in which the UE reestablished a bit earlier by increasing the CIO towards the reestablishment cell.

### SUMMARY

During 3GPP standardization meetings, it has been agreed that the UE should not declare master cell group (MCG) RLF when the UE's lower layers indicate a RACH issue while the T304 is running at the UE. In such a situation, if the UE declares RLF upon T304 expiry, then based on the existing procedures the network receives a RLF report in which the UE indicates the connectionFailureType as hof, thus pointing that the cause for RLF report generation is T304 expiry.

In general, when the connectionFailureType is set as hof, the network perceives the issue to be one of uplink (UL) coverage in the target cell. However, the issue could be related to consistent listen-before-talk (LBT) failures while trying to access the target cell, e.g., a situation where there is no UL coverage issue but where LBT issues lead to the failure. The existing RLF report contents could thus lead to wrong parameter tuning or non-optimal network behavior when eventually performing a recovery procedure.

Described herein are methods performed by a UE, where the UE includes an indicator in the RLF report indicating that the UE experienced LBT failure before declaring RLF due to the T304 expiry. Also described are methods performed by the UE, wherein the UE includes an indicator in the RLF report indicating that the UE experienced random access problem before declaring RLF due to the T304 expiry. These methods may be combined, in various embodiments.

According to some embodiments, a method performed by a wireless device during a handover from a first network node (to enable the network parameter optimization), comprises some or all of the steps of:
detecting at least one of the following:
   consistent uplink LBT failure while a handover related timer (T304) is running;
   random access problem while a handover related timer (T304) is running;
detecting that the handover related timer (T304) has expired;
storing a first information indicating at least one of the following:
   consistent uplink LBT failure was experienced while the handover related timer was running;
   random access problem was experienced while the handover related timer was running;
storing a second information indicating that the handover related timer expired;
performing reestablishment procedure towards a second network node; and
transmitting the first information and the second information to a third network node.

With the solutions described herein, the network can differentiate whether the UE declared handover failure due to UL coverage issues or due to LBT issues, the latter of which could occur purely because of congestion, despite there being good coverage. If the source node receives an RLF report in which the UE indicates the RLF report was generated due to T304 expiry and it had LBT issues, then the source node need not tune its UL coverage related parameters. On the other hand, if the source node receives an RLF report in which the UE indicates the RLF report was generated due to T304 expiry and it did not have any LBT issues, then the source node needs to tune its UL coverage related parameters.

### BRIEF DESCRIPTION OF FIGURES

FIG. 1 illustrates the ramifications of self-configuration and self-optimization functionality in 3GPP networks.

FIG. 2 is a process flow diagram illustrating an example method in a wireless device.

FIG. 3 is a process flow diagram illustrating an example method in a network node.

FIG. 4 shows an example of a communication system in accordance with some embodiments.

FIG. 5 shows a UE in accordance with some embodiments.

FIG. 6 shows a network node in accordance with some embodiments.

FIG. 7 is a block diagram of a host.

FIG. 8 is a block diagram illustrating a virtualization environment.

FIG. 9 shows a communication diagram of a host communicating via a network node with a UE over a partially wireless connection in accordance with some embodiments.

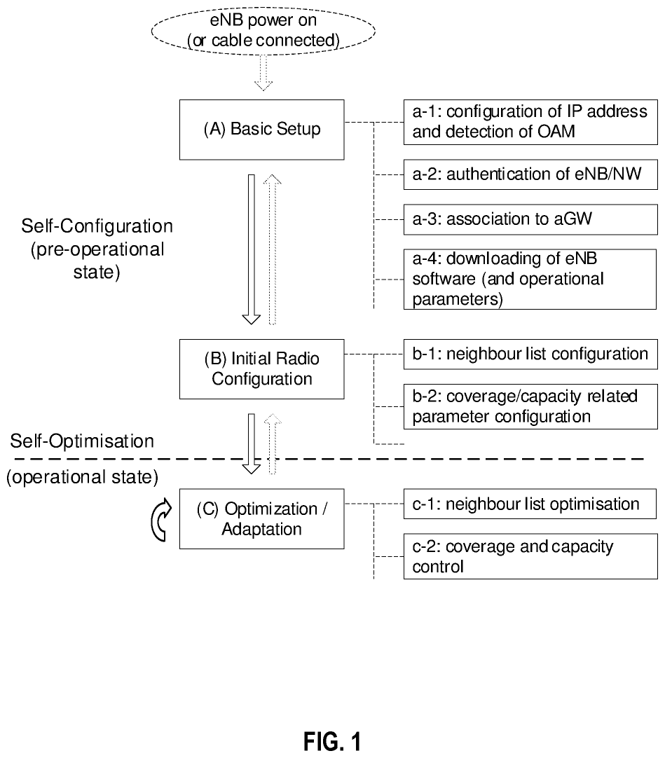

### DETAILED DESCRIPTION

Some of the embodiments contemplated herein will now be described more fully with reference to the accompanying drawings. Embodiments are provided by way of example to convey the scope of the subject matter to those skilled in the art.

The following description of various techniques relies upon NR-related examples. However, this is for illustration purposes only, as the techniques are applicable in other radio access technologies. Further, a main targeted scenario is when the UE is performing handover and starts the timer T304. But, the same methods and solution can also be applied to all those cases when the timer T304 is started upon reception of RRCReconfiguration message including reconfigurationWithSync or upon conditional reconfiguration execution, i.e., when applying a stored RRCReconfiguration message including reconfigurationWithSync. Further, the techniques described herein are not limited specifically to the handling of the timer T304 but can be applied to any other timer in any other radio access technologies that have a timer that have similar conditions for start, stop, and expiry of timer T304.

According to several embodiments of the presently disclosed techniques, the UE includes, in a report of a handover failure, an indication that the UE has experienced either an UL LBT failure or a random access problem before the T304 timer expired, leading to the RLF. A UL LBT failure flag may be set when one or more LBT failures were experienced when attempting to transmit a RACH message, e.g., msg1/msgA, or msg3, or when at least a certain number of LBT failures (said consistent LBT failure) were experienced when attempting to transmit a RACH message during this random access procedure in a certain UL BWP.

In some embodiments or instances of the disclosed techniques, the UE includes, in an RLF-Report, an indication that there was an RLF failure, e.g., by setting the “hof” flag in the connectionFailureType, and also includes an indication of the RLF cause, which could be LBT failures or random access problems. In this way, the network can figure out that there was a HOF, i.e., that T304 expired while the UE was performing the HO, and that the cause is LBT failure or random access problems.

In one method, the UE may include as the RLF cause only the random access problems, but at the same time provide an indicator that LBT failures were experienced during the random access procedure associated to this handover. For example, the UE may set the RLF cause as “randomAccessProblem” if the UE performed the maximum number of RACH preamble or msgA transmissions with no success. Additionally, the UE may include an indication of whether:
One or more LBT failures were experienced when attempting to transmit a RACH message (msg1, msgA, msg3),
A certain number of LBT failures (said consistent LBT failure) were experienced in one or more UL bandwidth part (BWPs), and the UL BWPs identifiers (IDs) (and optionally the associated UL BWP configuration(s)) in which consistent UL LBT failures were experienced.

With these techniques, the network can determine whether the UL LBT failures were the primary cause of the HOF or if the HOF was also due to other reasons. For example, if the UE includes only the randomAccessProblem as the RLF cause of the HO, but the UE also includes an indicator of LBT failures experienced during RA, the network may determine that LBT failures contributed to the random access problem, but also other factors contributed to the random access problems. For example, if a number of UL LBT failures included in the RLF-Report is small, the network may deduce that random access problem may be caused by downlink (DL) LBT failures experienced by the gNB.

Some example implementations (in NR RRC specification i.e., 3GPP TS 38.331) of the methods described herein are given below, with changes indicated in bold.

*************************begin excerpts of proposed specifications*****************

5.3.10.5 RLF report content determination

The UE shall determine the content in the VarRLF-Report as follows:
1> clear the information included in VarRLF-Report, if any;
1> set the plmn-IdentityList to include the list of EPLMNs stored by the UE (i.e. includes the RPLMN);
1> set the measResultLastServCell to include the cell level RSRP, RSRQ and the available SINK, of the source PCell (in case HO failure) or PCell (in case RLF) based on the available SSB and CSI-RS measurements collected up to the moment the UE detected failure;
1> if the SSlPBCH block-based measurement quantities are available:
2> set the rsIndexResults in measResultLastServCell to include all the available measurement quantities of the source PCell (in case HO failure) or PCell (in case RLF), ordered such that the highest SSlPBCH block RSRP is listed first if SSlPBCH block RSRP measurement results are available, otherwise the highest SSlPBCH block RSRQ is listed first if SSlPBCH block RSRQ cerement results are available, otherwise the highest SSlPBCH block SINR is listed first, based on the available SSlPBCH block based measurements collected up to the moment the UE detected failure;
1> if the CSI-RS based measurement quantities are available:
2> set the rsIndexResults in measResultLastServCell to include all the available measurement quantities of the source PCell (in case HO failure) or PCell (in case RLF), ordered such that the highest CSI-RS RSRP is listed first if CSI-RS RSRP measurement results are available, otherwise the highest CSI-RS RSRQ is listed first if CSI-RS RSRQ measurement results are available, otherwise the highest CSI-RS SINR is listed first, based on the available CSI-RS based measurements collected up to the moment the UE detected failure;
1> set the ssbRLMConfigBitmap and/or csi-rsRLMConfigBitmap in measResultLastServCell to include the radio link monitoring configuration of the source PCell (in case HO failure) or PCell (in case RLF);
1> for each of the configured measObjectNR in which measurements are available:
2> if the SSlPBCH block-based measurement quantities are available:
3> set the measResultListNR in measResultNeighCells to include all the available measurement quantities of the best measured cells, other than the source PCell (in case HO failure) or PCell (in case RLF), ordered such that the cell with highest SSlPBCH block RSRP is listed first if SSlPBCH block RSRP cerement results are available, otherwise the cell with highest SSlPBCH block RSRQ is listed first if SSlPBCH block RSRQ measurement results are available, otherwise the cell with highest SSlPBCH block SINR is listed first, based on the available SSlPBCH block based measurements collected up to the moment the UE detected failure;
4> for each neighbour cell included, include the optional fields that are available;
2> if the CSI-RS based measurement quantities are available:
3> set the measResultListNR in measResultNeighCells to include all the available measurement quantities of the best measured cells, other than the source PCell, ordered such that the cell with highest CSI-RS RSRP is listed first if CSI-RS RSRP measurement results are available, otherwise the cell with highest CSI-RS RSRQ is listed first if CSI-RS RSRQ measurement results are available, otherwise the cell with highest CSI-RS SINR is listed first, based on the available CSI-RS based measurements collected up to the moment the UE detected radio link failure;
4> for each neighbour cell included, include the optional fields that are available;
1> for each of the configured EUTRA frequencies in which measurements are available;
2> set the measResultListEUTRA in measResultNeighCells to include the best measured cells ordered such that the cell with highest RSRP is listed first if RSRP measurement results are available, otherwise the cell with highest RSRQ is listed first, and based on measurements collected up to the moment the UE detected failure;
3> for each neighbour cell included, include the optional fields that are available;
NOTE 1: The measured quantities are filtered by the L3 filter as configured in the mobility measurement configuration. The measurements are based on the time domain measurement resource restriction, if configured. Blacklisted cells are not required to be reported.
1> set the c-RNTI to the C-RNTI used in the source PCell (in case HO failure) or PCell (in case RLF);
1> if the failure is detected due to reconfiguration with sync failure as described in 5.3.5.8.3, set the fields in VarRLF-report as follows:
2> set the connectionFailureType to hof,
2> set the nrFailedPCellId in failedPCellId to the global cell identity and tracking area code, if available, and otherwise to the physical cell identity and carrier frequency of the target PCell of the failed handover,
2> include nrPreviousCell in previousPCellId and set it to the global cell identity and tracking area code of the PCell where the last RRCReconfiguration message including reconfigurationWithSync was received;
2> set the timeConnFailure to the elapsed time since reception of the last RRCReconfiguration message including the reconfigurationWithSync;
2> if the UE detected consistent uplink LBT failures while the timer T304 was running:
3> set the rlf-Cause as lbtFailure,
2> if the UE detected random access problem indication from MCG MAC while the timer T304 was running:
3> set the rlf-Cause as randomAccessProblem,
1> else if the failure is detected due to Mobility from NR failure as described in 5.4.3.5, set the fields in VarRLF-report as follows:
2> set the connectionFailureType to hof,
2> if last MobilityFromNRCommand concerned a failed inter-RAT handover from NR to E-UTRA and if the UE supports Radio Link Failure Report for Inter-RAT MRO EUTRA (NR to EUTRA):
3> set the eutraFailedPCellId in failedPCellId to the global cell identity and tracking area code, if available, and otherwise to the physical cell identity and carrier frequency of the target PCell of the failed handover,
2> include nrPreviousCell in previousPCellId and set it to the global cell identity and tracking area code of the PCell where the last MobilityFromNRCommand message was received;
2> set the timeConnFailure to the elapsed time since reception of the last MobilityFromNRCommand message;
2> if the UE detected consistent uplink LBT failures while the timer T304 was running:
3> set the rlf-Cause as lbtFailure,
2> if the UE detected random access problem indication from MCG MAC while the timer T304 was running:
3> set the rlf-Cause as randomAccessProblem,
1> else if the failure is detected due to radio link failure as described in 5.3.10.3, set the fields in VarRLF-report as follows:
2> set the connectionFailureType to r f,
2> set the rlf-Cause to the trigger for detecting radio link failure in accordance with clause 5.3.10.4;
2> set the nrFailedPCellId in failedPCellId to the global cell identity and the tracking area code, if available, and otherwise to the physical cell identity and carrier frequency of the PCell where radio link failure is detected;
2> if an RRCReconfiguration message including the reconfigurationWithSync was received before the connection failure:
3> if the last RRCReconfiguration message including the reconfigurationWithSync concerned an intra NR handover.
4> include the nrPreviousCell in previousPCellId and set it to the global cell identity and the tracking area code of the PCell where the last RRCReconfiguration message including reconfigurationWithSync was received;
4> set the timeConnFailure to the elapsed time since reception of the last RRCReconfiguration message including the reconfigurationWithSync;
3> else if the last RRCReconfiguration message including the reconfigurationWithSync concerned a handover to NR from E-UTRA and if the UE supports Radio Link Failure Report for Inter-RAT MRO EUTRA:
4> include the eutraPreviousCell in previousPCellId and set it to the global cell identity and the tracking area code of the E-UTRA PCell where the last RRCReconfiguration message including reconfigurationWithSync was received embedded in E-UTRA RRC message MobilityFromEUTRACommand message as specified in TS 36.331 [10] clause 5.4.3.3;
4> set the timeConnFailure to the elapsed time since reception of the last RRCReconfiguration message including the reconfigurationWithSync embedded in E-UTRA RRC message MobilityFromEUTRACommand message as specified in TS 36.331 [10] clause 5.4.3.3;
1> if connectionFailureType is rlf and the rlf-Cause is set to randomAccessProblem or beamFailureRecoveryFailure; or
1> if connectionFailureType is hof and if the failed handover is an infra-RAT handover.
2> set the ra-InformationCommon to include the random-access related information as described in subclause 5.7.10.5;
1> if available, set the locationInfo as in 5.3.3.7.

The UE may discard the radio link failure information or handover failure information, i.e. release the UE variable VarRLF-Report, 48 hours after the radio link failure/handover failure is detected.
NOTE 2: In this clause, the term ‘handover failure’ has been used to refer to ‘reconfiguration with sync failure’.

RLF-Report field descriptions

connectionFailureType
This field is used to indicate whether the connection failure is due to radio link
failure or handover failure.
csi-rsRLMConfigBitmap, csi-rsRLMConfigBitmap-v1650
These fields are used to indicate the CSI-RS indexes configured in the RLM
configurations for the active BWP when the UE declares RLF or HOF. The UE first
fills in the csi-rsRLMConfigBitmap-r16 to indicate the first 96 CSI-RS indexes and
then csi-rsRLMConfigBitmap-v1650 to indicate the latter 96 CSI-RS indexes. The
first/leftmost bit in csi-rsRLMConfigBitmap-r16 corresponds to CSI-RS index 0, the
second bit corresponds to CSI-RS index 1. The first/leftmost bit in
csi-rsRLMConfigBitmap-v1650 corresponds to CSI-RS index 96, the second bit
corresponds to CSI-RS index 97. These fields are included only if the
RadioLinkMonitoringConfig for the respective BWP is configured.
c-RNTI
This field indicates the C-RNTI used in the PCell upon detecting radio link failure or
the C-RNTI used in the source PCell upon handover failure.
failedPCellId
This field is used to indicate the PCell in which RLF is detected or the target PCell
of the failed handover. For intra-NR handover nrFailedPCellId is included and for
the handover from NR to EUTRA eutraFailedPCellId is included. The UE sets the
ARFCN according to the frequency band used for transmission/reception when the
failure occurred.
failedPCellId-EUTRA
This field is used to indicate the PCell in which RLF is detected or the source PCell
of the failed handover in an E-UTRA RLF report.
measResultListEUTRA
This field refers to the last measurement results taken in the neighboring EUTRA
Cells, when the radio link failure or handover failure happened.
measResultListNR
This field refers to the last measurement results taken in the neighboring NR Cells,
when the radio link failure or handover failure happened.
measResultLastServCell
This field refers to the log measurement results taken in the PCell upon detecting
radio link failure or the source PCell upon handover failure.
measResult-RLF-Report-EUTRA
Includes the E-UTRA RLF-Report-r9 IE as specified in TS 36.331 [10].
noSuitableCellFound
This field is set by the UE when the T311 expires.
previousPCellId
This field is used to indicate the source PCell of the last handover (source PCell
when the last RRCReconfiguration message including reconfigurationWithSync
was received). For intra-NR handover nrPreviousCell is included and for the
handover from EUTRA to NR eutraPreviousCell is included.
reconnectCellId
This field is used to indicate the cell in which the UE comes back to connected after
connection failure and after failing to perform reestablishment. If the UE comes
back to RRC CONNECTED in an NR cell then nrReconnectCellID is included and if
the UE comes back to RRC CONNECTED in an LTE cell then
eutraReconnectCellID is included
reestablishmentCellId
This field is used to indicate the cell in which the re-establishment attempt was
made after connection failure.
rlf-Cause
This field is used to indicate the cause of the last radio link failure that was
detected.
ssbRLMConfigBitmap
This field is used to indicate the SS/PBCH block indexes configured in the RLM
configurations for the active BWP when the UE declares RLF or HOF. The
first/leftmost bit corresponds to SSB index 0, the second bit corresponds to SSB
index 1. This field is included only if the RadioLinkMonitoringConfig for the
respective BWP is configured.
timeConnFailure
This field is used to indicate the time elapsed since the last HO initialization until
connection failure. Actual value = field value * 100 ms. The maximum value 1023
means 102.3 s or longer.
timeSinceFailure
This field is used to indicate the time that elapsed since the connection (radio link
or handover) failure. Value in seconds. The maximum value 172800 means
172800 s or longer.
timeUntilReconnection
This field is used to indicate the time that elapsed between the connection (radio
link or handover) failure and the next time the UE comes to RRC CONNECTED in
an NR or EUTRA cell, after failing to perform reestablishment. Value in seconds.
The maximum value 172800 means 172800 s or longer.

**********************end excerpts of proposed specifications**********************

In other embodiments or instances of the techniques described herein, rather than explicitly including an LBT failure indicator, the UE may include in the RLF-Report the information element RA-InformationCommon, which in turn may contain for each RA-attempt an indication of whether the corresponding RA-attempt suffered LBT issues either in the msg1/msgA transmission or in the msg3. Additionally, such RA-Attempt may contain the UL BWP ID(s) or the UL BPW associated configuration, so that the network can determine the UL BWP where the LBT failure occurred. For example, the UL BWP IDs and/or the related configuration may be included in a list in which the UL BWPs are included in chronological order of use. Alternatively, the UL BWPs ID might be included within each RA attempt information. This could also be an explicit indication of the exact UL frequency resources associated to the used RA resources in each BWP instead of just UL BWP IDs. In some other embodiments, the UE could include a list of RA-InformationCommon when the UE performs random access in more than one BWP while experiencing the LBT failure.

The UE may also include in the report the value of the threshold configured by the network to the UE for the consistent UL LBT failure. In this way, the network can count the number of RA attempts for which an LBT was experienced by the UE for each used UL BWP, and by comparing this number with the said threshold, the network can determine whether consistent UL LBT failures were reached in one or more of the used UL BWPs.

An excerpt of ASN.1 message definition that captures the above method is given below.

*******************begin proposed ASN.1*****************************

UEInformationResponse message

-- ASN1START
-- TAG-UEINFORMATIONRESPONSE-START

| | |
|---|---|
| UEInformationResponse-r16 ::= | SEQUENCE { |
| rrc-TransactionIdentifier | RRC- |

TransactionIdentifier,

| | |
|---|---|
| criticalExtensions | CHOICE { |

ueInformationResponse-r16
UEInformationResponse-r16-IEs,

| | |
|---|---|
| criticalExtensionsFuture | SEQUENCE { } |

}
}

| | |
|---|---|
| UEInformationResponse-r16-IEs ::= | SEQUENCE { |
| measResultIdleEUTRA-r16 | MeasResultIdleEUTRA- |

r16 OPTIONAL,

| | |
|---|---|
| measResultIdleNR-r16 | MeasResultIdleNR-r16 |

OPTIONAL,

| | |
|---|---|
| logMeasReport-r16 | LogMeasReport-r16 |

OPTIONAL,

| | |
|---|---|
| connEstFailReport-r16 | ConnEstFailReport-r16 |

OPTIONAL,

| | |
|---|---|
| ra-ReportList-r16 | RA-ReportList-r16 |

OPTIONAL,

| | |
|---|---|
| rlf-Report-r16 | RLF-Report-r16 |

OPTIONAL,
mobilityHistoryReport-r16

| | |
|---|---|
| MobilityHistoryReport-r16 | OPTIONAL, |
| lateNonCriticalExtension | OCTET STRING |

OPTIONAL,

| | |
|---|---|
| nonCriticalExtension | SEQUENCE { } |

OPTIONAL
}

| | |
|---|---|
| LogMeasReport-r16 ::= | SEQUENCE { |
| absoluteTimeStamp-r16 | AbsoluteTimeInfo-r16, |
| traceReference-r16 | TraceReference-r16, |
| traceRecordingSessionRef-r16 | OCTET STRING (SIZE |

(2)),

| | |
|---|---|
| tce-Id-r16 | OCTET STRING (SIZE |

(1)),

| | |
|---|---|
| logMeasInfoList-r16 | LogMeasInfoList-r16, |
| logMeasAvailable-r16 | ENUMERATED {true} |

OPTIONAL,

| | |
|---|---|
| logMeasAvailableBT-r16 | ENUMERATED {true} |

OPTIONAL,

| | |
|---|---|
| logMeasAvailableWLAN-r16 | ENUMERATED {true} |

OPTIONAL,
...
}

| | |
|---|---|
| LogMeasInfoList-r16 ::= | SEQUENCE (SIZE |

(1..maxLogMeasReport-r16)) OF LogMeasInfo-r16

| | |
|---|---|
| LogMeasInfo-r16 ::= | SEQUENCE { |
| locationInfo-r16 | LocationInfo-r16 |

OPTIONAL,

| | |
|---|---|
| relativeTimeStamp-r16 | INTEGER (0..7200), |
| servCellIdentity-r16 | CGI-Info-Logging-r16 |

OPTIONAL,
measResultServingCell-r16

| | |
|---|---|
| MeasResultServingCell-r16 | OPTIONAL, |
| measResultNeighCells-r16 | SEQUENCE { |

measResultNeighCellListNR

| | |
|---|---|
| MeasResultListLogging2NR-r16 | OPTIONAL, |

measResultNeighCellListEUTRA

| | |
|---|---|
| MeasResultList2EUTRA-r16 | OPTIONAL |

},

| | |
|---|---|
| anyCellSelectionDetected-r16 | ENUMERATED {true} |

OPTIONAL,
...
}

| | |
|---|---|
| ConnEstFailReport-r16 ::= | SEQUENCE { |
| measResultFailedCell-r16 | MeasResultFailedCell- |

r16,

| | |
|---|---|
| locationInfo-r16 | LocationInfo-r16 |

OPTIONAL,

| | |
|---|---|
| measResultNeighCells-r16 | SEQUENCE { |

measResultNeighCellListNR

| | |
|---|---|
| MeasResultList2NR-r16 | OPTIONAL, |

measResultNeighCellListEUTRA

| | |
|---|---|
| MeasResultList2EUTRA-r16 | OPTIONAL |

},

| | |
|---|---|
| numberOfConnFail-r16 | INTEGER (1..8), |

perRAInfoList-r16
PerRAInfoList-r16,

| | |
|---|---|
| timeSinceFailure-r16 | TimeSinceFailure-r16, |

...
}

| | |
|---|---|
| MeasResultServingCell-r16 ::= | SEQUENCE { |
| resultsSSB-Cell | MeasQuantityResults, |
| resultsSSB | SEQUENCE { |
| best-ssb-Index | SSB-Index, |

best-ssb-Results
MeasQuantityResults,

| | |
|---|---|
| numberOfGoodSSB | INTEGER |

(1..maxNrofSSBs-r16)
}
OPTIONAL
}

| | |
|---|---|
| MeasResultFailedCell-r16 ::= | SEQUENCE { |
| cgi-Info | CGI-Info-Logging-r16, |
| measResult-r16 | SEQUENCE { |
| cellResults-r16 | SEQUENCE { |

```
      resultsSSB-Cell-r16
MeasQuantityResults
    },
```

| | |
|---|---|
| rsIndexResults-r16 | SEQUENCE { |

```
      resultsSSB-Indexes-r16
ResultsPerSSB-IndexList
    }
  }
}
RA-ReportList-r16 ::= SEQUENCE (SIZE (1..maxRAReport-r16)) OF
RA-Report-r16
```

| | |
|---|---|
| RA-Report-r16 ::= | SEQUENCE { |
| cellId-r16 | CHOICE { |
| cellGlobalId-r16 | CGI-Info-Logging- |

r16,

| | |
|---|---|
| pci-arfcn-r16 | SEQUENCE { |
| physCellId-r16 | PhysCellId, |
| carrierFreq-r16 | ARFCN-ValueNR |

```
    }
  },
```

| ra-InformationCommon-r16 | | RA-InformationCommon- |
|---|---|---|
| r16 | OPTIONAL, | |
| raPurpose-r16 | | ENUMERATED |

{accessRelated, beamFailureRecovery, reconfigurationWithSync,
ulUnSynchronized,
schedulingRequestFailure, noPUCCHResourceAvailable,
requestForOtherSI,

spare9,

spare8, spare7, spare6, spare5, spare4, spare3, spare2,
spare1},
...
}

| | |
|---|---|
| RA-InformationCommon-r16 ::= | SEQUENCE { |
| absoluteFrequencyPointA-r16 | ARFCN-ValueNR, |
| locationAndBandwidth-r16 | INTEGER (0..37949), |
| subcarrierSpacing-r16 | SubcarrierSpacing, |
| msg1-FrequencyStart-r16 | INTEGER |
| (0..maxNrofPhysicalResourceBlocks-1) | OPTIONAL, |
| msg1-FrequencyStartCFRA-r16 | INTEGER |
| (0..maxNrofPhysicalResourceBlocks-1) | OPTIONAL, |
| msg1-SubcarrierSpacing-r16 | SubcarrierSpacing |

OPTIONAL,

| | |
|---|---|
| msg1-SubcarrierSpacingCFRA-r16 | SubcarrierSpacing |

OPTIONAL,

| msg1-FDM-r16 | | ENUMERATED {one, two, |
|---|---|---|
| four, eight} | OPTIONAL, | |
| msg1-FDMCFRA-r16 | | ENUMERATED {one, two, |
| four, eight} | OPTIONAL, | |
| perRAInfoList-r16 | | PerRAInfoList-r16, |

```
  lbt-FailureInstanceMaxCountConfig ENUMERATED {n4, n8,
n16, n32, n64, n128},
  usedULBWPs-r16 ::= SEQUENCE (SIZE (1.. maxNrofBWPs)) OF
BWP-Id
  ...
}
PerRAInfoList-r16 ::= SEQUENCE (SIZE (1..200)) OF PerRAInfo-
r16
```

| | |
|---|---|
| PerRAInfo-r16 ::= | CHOICE { |
| perRASSBInfoList-r16 | PerRASSBInfo-r16 |
| perRACSI-RSInfoList-r16 | PerRACSI-RSInfo-r16 |

}

| | |
|---|---|
| PerRASSBInfo-r16 ::= | SEQUENCE { |
| ssb-Index-r16 | SSB-Index, |
| numberOfPreamblesSentOnSSB-r16 | INTEGER (1..200), |
| perRAAttemptInfoList-r16 | PerRAAttemptInfoList- |

r16
}

| | |
|---|---|
| PerRACSI-RSInfo-r16 ::= | SEQUENCE { |
| csi-RS-Index-r16 | CSI-RS-Index, |
| numberOfPreamblesSentOnCSI-RS-r16 | INTEGER (1..200) |

}

| | |
|---|---|
| PerRAAttemptInfoList-r16 ::= | SEQUENCE (SIZE (1..200)) |

OF PerRAAttemptInfo-r16

| | |
|---|---|
| PerRAAttemptInfo-r16 ::= | SEQUENCE { |
| contentionDetected-r16 | BOOLEAN |

OPTIONAL,

| | |
|---|---|
| dlRSRPAboveThreshold-r16 | BOOLEAN |

OPTIONAL,

| | |
|---|---|
| msg1LBT | BOOLEAN |

OPTIONAL,

| | |
|---|---|
| msgALBT | BOOLEAN |

OPTIONAL,

| | |
|---|---|
| msg3LBT | BOOLEAN |

OPTIONAL,
...
}

| | |
|---|---|
| RLF-Report-r16 ::= | CHOICE { |
| nr-RLF-Report-r16 | SEQUENCE { |
| measResultLastServCell-r16 | MeasResultRLFNR- |

r16,

| | |
|---|---|
| measResultNeighCells-r16 | SEQUENCE { |

measResultListNR-r16

| | |
|---|---|
| MeasResultList2NR-r16 | OPTIONAL, |

measResultListEUTRA-r16

| | |
|---|---|
| MeasResultListEUTRA-r16 | OPTIONAL |

}
OPTIONAL,

| | |
|---|---|
| c-RNTI-r16 | RNTI-Value, |
| previousPCellId-r16 | CHOICE { |
| nrPreviousCell-r16 | CGI-Info- |

Logging-r16,

| | |
|---|---|
| eutraPreviousCell-r16 | CGI- |

InfoEUTRALogging
}
OPTIONAL,

| | |
|---|---|
| failedPCellId-r16 | CHOICE { |
| nrFailedPCellId-r16 | CHOICE { |
| cellGlobalId-r16 | CGI-Info- |

Logging-r16,

| | |
|---|---|
| pci-arfcn-r16 | SEQUENCE |

```
{
          physCellId-r16
PhysCellId,
          carrierFreq-r16
ARFCN-ValueNR
        }
      },
```

| | |
|---|---|
| eutraFailedPCellId-r16 | CHOICE { |
| cellGlobalId-r16 | CGI- |

InfoEUTRALogging,

| | |
|---|---|
| pci-arfcn-r16 | SEQUENCE { |
| physCellId-r16 | EUTRA- |

PhysCellId,

| | |
|---|---|
| carrierFreq-r16 | ARFCN- |

```
ValueEUTRA
        }
      }
    },
```

| | |
|---|---|
| reconnectCellId-r16 | CHOICE { |
| nrReconnectCellId-r16 | CGI-Info- |

Logging-r16,

| | |
|---|---|
| eutraReconnectCellId-r16 | CGI- |

```
InfoEUTRALogging
    }
OPTIONAL,
    timeUntilReconnection-r16
```

| | |
|---|---|
| TimeUntilReconnection-r16 | OPTIONAL, |
| reestablishmentCellId-r16 | CGI-Info-Logging- |
| r16 | OPTIONAL, |
| timeConnFailure-r16 | INTEGER (0..1023) |

OPTIONAL,

| | |
|---|---|
| timeSinceFailure-r16 | TimeSinceFailure- |

r16,

| | |
|---|---|
| connectionFailureType-r16 | ENUMERATED {rlf, |

hof},

| | |
|---|---|
| rlf-Cause-r16 | ENUMERATED {t310- |

Expiry, randomAccessProblem, rlc-MaxNumRetx,
beamFailureRecoveryFailure, lbtFailure-r16,

bh-

rlfRecoveryFailure, spare2, spare1},

| | |
|---|---|
| locationInfo-r16 | LocationInfo-r16 |

OPTIONAL,

| | |
|---|---|
| noSuitableCellFound-r16 | ENUMERATED {true} |

OPTIONAL,

| | |
|---|---|
| ra-InformationCommon-r16 | RA- |
| InformationCommon-r16 | OPTIONAL, |

```
    ...,
    [[
```

| | |
|---|---|
| csi-rsRLMConfigBitmap-v1650 | BIT STRING (SIZE |
| (96)) | OPTIONAL |

```
    ]]
  },
```

| | |
|---|---|
| eutra-RLF-Report-r16 | SEQUENCE { |
| failedPCellId-EUTRA | CGI- |

InfoEUTRALogging,

| | |
|---|---|
| measResult-RLF-Report-EUTRA-r16 | OCTET STRING, |

```
    ...
  }
}
```

| | |
|---|---|
| MeasResultList2NR-r16 ::= | SEQUENCE (SIZE |

(1..maxFreq)) OF MeasResult2NR-r16

| | |
|---|---|
| MeasResultList2EUTRA-r16 ::= | SEQUENCE (SIZE |

(1..maxFreq)) OF MeasResult2EUTRA-r16

| | |
|---|---|
| MeasResult2NR-r16 ::= | SEQUENCE { |
| ssbFrequency-r16 | ARFCN-ValueNR |

OPTIONAL,

| | |
|---|---|
| refFreqCSI-RS-r16 | ARFCN-ValueNR |

OPTIONAL,

| | |
|---|---|
| measResultList-r16 | MeasResultListNR |

}

| | |
|---|---|
| MeasResultListLogging2NR-r16 ::= | SEQUENCE (SIZE |

(1..maxFreq)) OF MeasResultLogging2NR-r16

| | |
|---|---|
| MeasResultLogging2NR-r16 ::= | SEQUENCE { |
| carrierFreq-r16 | ARFCN-ValueNR, |

measResultListLoggingNR-r16
MeasResultListLoggingNR-r16
}

| | |
|---|---|
| MeasResultListLoggingNR-r16 ::= | SEQUENCE (SIZE |

(1..maxCellReport)) OF MeasResultLoggingNR-r16

| | |
|---|---|
| MeasResultLoggingNR-r16 ::= | SEQUENCE { |
| physCellId-r16 | PhysCellId, |
| resultsSSB-Cell-r16 | MeasQuantityResults, |
| numberOfGoodSSB-r16 | INTEGER |

(1..maxNrofSSBs-r16) OPTIONAL
}

| | |
|---|---|
| MeasResult2EUTRA-r16 ::= | SEQUENCE { |
| carrierFreq-r16 | ARFCN-ValueEUTRA, |
| measResultList-r16 | MeasResultListEUTRA |

}

| | |
|---|---|
| MeasResultRLFNR-r16 ::= | SEQUENCE { |
| measResult-r16 | SEQUENCE { |
| cellResults-r16 | SEQUENCE{ |

resultsSSB-Cell-r16

| | |
|---|---|
| MeasQuantityResults | OPTIONAL, |

resultsCSI-RS-Cell-r16

| | |
|---|---|
| MeasQuantityResults | OPTIONAL |

},

| | |
|---|---|
| rsIndexResults-r16 | SEQUENCE{ |

resultsSSB-Indexes-r16

| | |
|---|---|
| ResultsPerSSB-IndexList | OPTIONAL, |
| ssbRLMConfigBitmap-r16 | BIT STRING |
| (SIZE (64)) | OPTIONAL, |

resultsCSI-RS-Indexes-r16

| | |
|---|---|
| ResultsPerCSI-RS-IndexList | OPTIONAL, |
| csi-rsRLMConfigBitmap-r16 | BIT STRING |
| (SIZE (96)) | OPTIONAL |

```
    }
OPTIONAL
  }
}
TimeSinceFailure-r16 ::= INTEGER (0..172800)
MobilityHistoryReport-r16 ::= VisitedCellInfoList-r16
TimeUntilReconnection-r16 ::= INTEGER (0..172800)
-- TAG-UEINFORMATIONRESPONSE-STOP
-- ASN1STOP
```

UEInformationResponse-IEs field descriptions

logMeasReport
This field is used to provide the measurement results stored by the UE associated to logged
MDT.
measResultIdleEUTRA
EUTRA measurement results performed during RRC_INACTIVE or RRC_IDLE.
measResultIdleNR
NR measurement results performed during RRC_INACTIVE or RRC_IDLE.
ra-ReportList
This field is used to provide the list of RA reports that is stored by the UE for the past upto
maxRAReport-r16 number of successful random access procedures.
rlf-Report
This field is used to indicate the RLF report related contents.

LogMeasReport field descriptions

absoluteTimeStamp
Indicates the absolute time when the logged measurement configuration logging is provided,
as indicated by NR within absoluteTimeInfo.
anyCellSelectionDetected
This field is used to indicate the detection of any cell selection state, as defined in TS 38.304
[20]. The UE sets this field when performing the logging of measurement results in
RRC_IDLE or RRC_INACTIVE and there is no suitable cell or no acceptable cell.
measResultServingCell
This field refers to the log measurement results taken in the Serving cell.
numberOfGoodSSB
Indicates the number of good beams (beams that are above absThreshSS-BlocksConsolidation,
if configured by the network) associated to the cells within the R value range (which is
configured by network for cell reselection) of the highest ranked cell as part of
the beam level measurements. If the UE has no SSB of a neighbour cell whose measurement
quantity is above the absThreshSS-BlocksConsolidation or if the network has not
configured the absThreshSS-BlocksConsolidation, then the UE does not include
numberOfGoodSSB for the corresponding neighbour cell. If the UE has no SSB of the
serving cell whose measurement quantity is above the absThreshSS-BlocksConsolidation or
if the network has not configured the absThreshSS-BlocksConsolidation, then the UE shall
set the numberOfGoodSSB for the serving cell to one.
relativeTimeStamp
Indicates the time of logging measurement results, measured relative to the
absoluteTimeStamp. Value in seconds.
tce-Id
Parameter Trace Collection Entity Id: See TS 32.422 [52].
traceRecordingSessionRef
Parameter Trace Recording Session Reference: See TS 32.422 [52].

ConnEstFailReport field descriptions

measResultFailedCell
This field refers to the last measurement results taken in the cell, where connection
establishment failure or connection resume failure happened.
measResultNeighCells
This field refers to the neighbour cell measurements when connection establishment failure
or connection resume failure happened.
numberOfConnFail
This field is used to indicate the latest number of consecutive failed RRCSetup or
RRCResume procedures in the same cell independent of RRC state transition.
numberOfPreamblesSent
This field is used to indicate the number of random access preambles that were transmitted.
timeSinceFailure
This field is used to indicate the time that elapsed since the connection (establishment or
resume) failure. Value in seconds. The maximum value 172800 means 172800 s or longer.

RA-Report field descriptions

absoluteFrequencyPointA
This field indicates the absolute frequency position of the reference resource block
(Common RB 0).
cellID
This field indicates the CGI of the cell in which the associated random access procedure
was performed.
contentionDetected
This field is used to indicate that contention was detected for the transmitted preamble in the
given random access attempt or not. This field is not included when the UE performs random
access attempt is using contention free random-access resources or when the raPurpose is
set to requestForOtherSI.
csi-RS-Index
This field is used to indicate the CSI-RS index corresponding to the random access attempt.
dlRSRPAboveThreshold
This field is used to indicate whether the DL beam (SSB) quality associated to the random
access attempt was above or below the threshold rsrp-ThresholdSSB in
beamFailureRecoveryConfig in UL BWP configuration of UL BWP selected for random
access procedure initiated for beam failure recovery; Otherwise, rsrp-ThresholdSSB in
rach-ConfigCommon in UL BWP configuration of UL BWP selected for random access procedure.
lbt-FailureInstanceMaxCountConfig
Value of the lbt-FailureInstanceMaxCount configured by the network
locationAndBandwidth
Frequency domain location and bandwidth of the bandwidth part associated to the
random-access resources used by the UE.
msg1LBT, msgALBT, msg3LBT
This field is used to indicate whether for the corresponding RA attempt an LBT failure
was experienced when attempting to transmit msg1, or msgA, or msg3
numberOfPreamblesSentOnCSI-RS
This field is used to indicate the total number of successive RA preambles that were
transmitted on the corresponding CSI-RS.
numberOfPreamblesSentOnSSB
This field is used to indicate the total number of successive RA preambles that were
transmitted on the corresponding SS/PBCH block.
perRAAttemptInfoList
This field provides detailed information about a random access attempt.
perRAInfoList
This field provides detailed information about each of the random access attempts in the
chronological order of the random access attempts.
perRACSI-RSInfoList
This field provides detailed information about the successive random access attempts
associated to the same CSI-RS.
perRASSBInfoList
This field provides detailed information about the successive random access attempts
associated to the same SS/PBCH block.
raPurpose
This field is used to indicate the RA scenario for which the RA report entry is triggered. The
RA accesses associated to Initial access from RRC_IDLE, RRC re-establishment procedure,
transition from RRC-INACTIVE and the MSG3 based SI request are indicated using the
indicator ‘accessRelated’. The indicator beamFailureRecovery is used in case of successful
beam failure recovery related RA procedure in the SpCell [3]. The indicator
reconfigurationWithSync is used if the UE executes a reconfiguration with sync. The indicator
ulUnSynchronized is used if the random access procedure is initiated in a SpCell by DL or UL
data arrival during RRC_CONNECTED when the timeAlignmentTimer is not running in the
PTAG or if the RA procedure is initiated in a serving cell by a PDCCH order [3]. The indicator
schedulingRequestFailure is used in case of SR failures [3]. The indicator
noPUCCHResourceAvailable is used when the UE has no valid SR PUCCH resources
configured [3]. The indicator requestForOtherSI is used for MSG1 based on demand SI request.
ra-InformationCommon
This field is used to indicate the common random-access related information between RA-report
and RLF-report. For RA report, this field is mandatory presented. For RLF-report, this
field is optionally included when connectionFailureType is set to ‘hof’ or when
connectionFailureType is set to ‘rlf’ and the rlf-Cause equals to ‘randomAccessProblem’ or
‘beamRecoveryFailure’; otherwise this field is absent.
ssb-Index
This field is used to indicate the SS/PBCH index of the SS/PBCH block corresponding to the
random access attempt.
subcarrierSpacing
Subcarrier spacing used in the BWP associated to the random-access resources used by the
UE.
usedULBWPs
List of UL BWPs in chronological order used during the random access procedure

RLF-Report field descriptions

connectionFailureType
This field is used to indicate whether the connection failure is due to radio link failure or
handover failure.
csi-rsRLMConfigBitmap, csi-rsRLMConfigBitmap-v1650
These fields are used to indicate the CSI-RS indexes configured in the RLM configurations
for the active BWP when the UE declares RLF or HOF. The UE first fills in the
csi-rsRLMConfigBitmap-r16 to indicate the first 96 CSI-RS indexes and then
csi-rsRLMConfigBitmap-v1650 to indicate the latter 96 CSI-RS indexes. The first/leftmost bit in
csi-rsRLMConfigBitmap-r16 corresponds to CSI-RS index 0, the second bit corresponds to
CSI-RS index 1. The first/leftmost bit in csi-rsRLMConfigBitmap-v1650 corresponds to
CSI-RS index 96, the second bit corresponds to CSI-RS index 97. These fields are included
only if the RadioLinkMonitoringConfig for the respective BWP is configured.
c-RNTI
This field indicates the C-RNTI used in the PCell upon detecting radio link failure or the
C-RNTI used in the source PCell upon handover failure.
failedPCellId
This field is used to indicate the PCell in which RLF is detected or the target PCell of the
failed handover. For intra-NR handover nrFailedPCellId is included and for the handover
from NR to EUTRA eutraFailedPCellId is included. The UE sets the ARFCN according to
the frequency band used for transmission/reception when the failure occurred.
failedPCellId-EUTRA
This field is used to indicate the PCell in which RLF is detected or the source PCell of the
failed handover in an E-UTRA RLF report.
measResultListEUTRA
This field refers to the last measurement results taken in the neighboring EUTRA Cells,
when the radio link failure or handover failure happened.
measResultListNR
This field refers to the last measurement results taken in the neighboring NR Cells, when
the radio link failure or handover failure happened.
measResultLastServCell
This field refers to the log measurement results taken in the PCell upon detecting radio link
failure or the source PCell upon handover failure.
measResult-RLF-Report-EUTRA
Includes the E-UTRA RLF-Report-r9 IE as specified in TS 36.331 [10].
noSuitableCellFound
This field is set by the UE when the T311 expires.
previousPCellId
This field is used to indicate the source PCell of the last handover (source PCell when the
last RRCReconfiguration message including reconfigurationWithSync was received). For
intra-NR handover nrPreviousCell is included and for the handover from EUTRA to NR
eutraPreviousCell is included.
reconnectCellId
This field is used to indicate the cell in which the UE comes back to connected after
connection failure and after failing to perform reestablishment. If the UE comes back to
RRC CONNECTED in an NR cell then nrReconnectCellID is included and if the UE comes
back to RRC CONNECTED in an LTE cell then eutraReconnectCellID is included
reestablishmentCellId
This field is used to indicate the cell in which the re-establishment attempt was made after
connection failure.
rlf-Cause
This field is used to indicate the cause of the last radio link failure that was detected. In
case of handover failure information reporting (i.e., the connectionFailureType is set to
‘hof’), the UE is allowed to set this field to any value.
ssbRLMConfigBitmap
This field is used to indicate the SS/PBCH block indexes configured in the RLM
configurations for the active BWP when the UE declares RLF or HOF. The first/leftmost bit
corresponds to SSB index 0, the second bit corresponds to SSB index 1. This field is
included only if the RadioLinkMonitoringConfig for the respective BWP is configured.
timeConnFailure
This field is used to indicate the time elapsed since the last HO initialization until connection
failure. Actual value = field value * 100 ms. The maximum value 1023 means 102.3 s or
longer.
timeSinceFailure
This field is used to indicate the time that elapsed since the connection (radio link or
handover) failure. Value in seconds. The maximum value 172800 means 172800 s or
longer.
timeUntilReconnection
This field is used to indicate the time that elapsed between the connection (radio link or
handover) failure and the next time the UE comes to RRC CONNECTED in an NR or
EUTRA cell, after failing to perform reestablishment. Value in seconds. The maximum value
172800 means 172800 s or longer.

*******************end proposed ASN.1*****************************

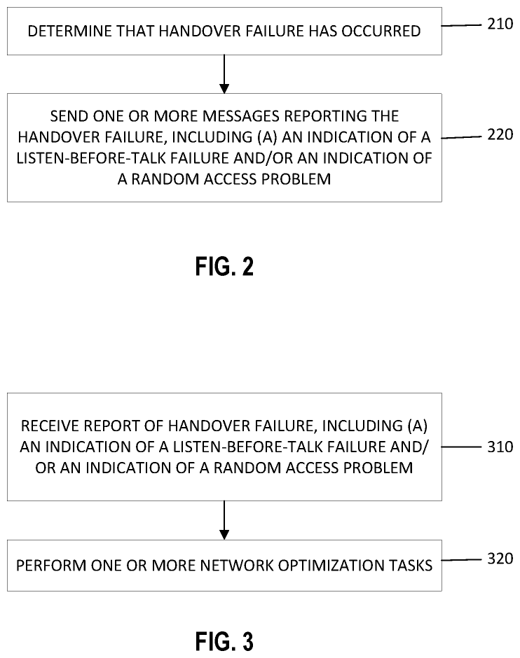

In view of the techniques described above, it will be appreciated that FIG. 2 illustrates an example method for reporting HOF in a wireless network, as implemented in a wireless device, e.g., a UE operating in an LTE or NR (or other) wireless network. The illustrated method is intended to be a generalization of the techniques described above and to encompass those techniques. Thus, where terminology used in the description of the method shown in FIG. 2 differs somewhat from the examples and illustrations provided above, the terminology used below should be understood as interchangeable with or encompassing the similar terminology used above, except where the context makes it clear otherwise.

As shown at block 210, the method shown in FIG. 2 includes the step of determining that a HOF has occurred in connection with a reconfiguration of at least one connection of the wireless device to the wireless network. In a 3GPP network, this reconfiguration may be a so-called “reconfiguration with sync,” as the illustrated method takes place in the context of handover.

As shown at block 220, the method further includes the step of sending, to the wireless network, one or more messages reporting the HOF, the one or more messages comprising one or both of (a) an indication of at least one listen-before-talk, LBT, failure experienced by the wireless device in connection with the reconfiguration or (b) an indication of a random access problem experienced by the wireless device in connection with the reconfiguration. Note that the one or more messages may be sent to the same base station/cell that was the target of the handover or to a different one, depending on how the wireless device recovers from the HOF. As was discussed above, the one or more messages reporting the HOF may, in some embodiments, be sent in response to a request from the network, which may in turn be in response to the inclusion of a flag sent to the network by the wireless device, the flag indicating the availability of the report.

In some embodiments or instances, determining that the HOF has occurred, as in block 210, comprises detecting expiry of a reconfiguration timer, such as the T304 as defined by 3GPP specifications. In such embodiments or instances, the one or more messages may further indicate expiry of the reconfiguration timer as a cause of the HOF. Likewise, the one or more messages may include a cause indication indicating random access problem as a cause of the HOF, e.g., as an additional cause indication. Alternatively or in addition, the one or more messages may comprise a cause indication indicating LBT failure as a cause of the HOF, e.g., as an additional cause.

In some embodiments or instances, the one or more messages may comprise an explicit flag indicating that at least one LBT failure was experienced by the wireless device in connection with the reconfiguration. In some embodiments or instances, the one or more messages may instead comprise a flag indicating that at least a predetermined minimum number of LBT failures were experienced by the wireless device in connection with the reconfiguration. This predetermined minimum number may be a configured parameter, i.e., where the network previously provided the wireless device with the predetermined minimum number.

In some embodiments or instances, the one or more messages may identify at least one uplink bandwidth part (UL BWP) in which at least one LBT failure was experienced by the wireless device. In some embodiments or instances, the one or more messages may indicate an uplink message for which at least one LBT failure was experienced by the wireless device.

In some embodiments or instances, the one or more messages may comprise, for each of one or more random access attempts associated with the RLF, an indication of whether the respective random access attempt suffered an LBT failure in transmitting a random access message. In some of these embodiments or instances, the one or more messages may further comprise an identifier of an uplink bandwidth part or an identifier of an uplink bandwidth part configuration. Likewise, in some of these embodiments or instances, the one or more messages may further comprise an indication of uplink resources associated with each of at least one of the random access attempts.

In some embodiments or instances, the one or more messages may further comprise a threshold number of LBT failures used by the wireless device to determine a consistent LBT failure.

FIG. 3 illustrates a corresponding method for optimizing network performance, in a wireless network. This method may be implemented in one (or several) network nodes, in various embodiments or instances. As was the case with FIG. 2, the method illustrated in FIG. 3 is intended to be a generalization of the techniques described above and to encompass those techniques. Thus, where terminology used in the description of the method shown in FIG. 3 differs somewhat from the examples and illustrations provided above, the terminology used below should be understood as interchangeable with or encompassing the similar terminology used above, except where the context makes it clear otherwise.

As shown at block 310, the method includes the step of receiving a report of a HOF experienced by a wireless device in connection with a reconfiguration of at least one connection of the wireless device to the wireless network, the report comprising one or both of (a) an indication of at least one listen-before-talk, LBT, failure experienced by the wireless device in connection with the reconfiguration or (b) an indication of a random access problem experienced by the wireless device in connection with the reconfiguration. Again, in a 3GPP network, this reconfiguration may be a so-called “reconfiguration with sync,” as the illustrated method takes place in the context of handover.

As shown at block 320, the method further includes the step of performing one or more network optimization tasks, based on the indication.

In some embodiments or instances, the report further indicates expiry of a reconfiguration timer as a cause of the HOF. In some embodiments or instances, the report may comprise a cause indication indicating random access problem as a cause of the HOF, e.g., as an additional cause. Likewise, the report may comprise a cause indication indicating LBT failure as a cause of the HOF, e.g., as an additional cause.

In some embodiments or instances, the report may comprise a flag indicating that at least one LBT failure was experienced by the wireless device in connection with the reconfiguration. Alternatively, in some embodiments or instances, the report may comprise a flag indicating that at least a predetermined minimum number of LBT failures were experienced by the wireless device in connection with the reconfiguration.

In some embodiments or instances, the report may identify at least one UL BWP in which at least one LBT failure was experienced by the wireless device. Alternatively or additionally, the report may identify an uplink message for which at least one LBT failure was experienced by the wireless device.

In some embodiments or instances, the report may comprise, for each of one or more random access attempts associated with the RLF, an indication of whether the respective random access attempt suffered an LBT failure in transmitting a random access message. In some of these embodiments or instances, the report may further comprise an identifier of an uplink bandwidth part or an identifier of an uplink bandwidth part configuration. Alternatively, the report may further comprise an indication of uplink resources associated with each of at least one of the random access attempts.

In some embodiments or instances, the report may further comprise a threshold number of LBT failures used by the wireless device to determine a consistent LBT failure.

In some embodiments or instances, performing one or more network optimization tasks may comprise tuning a network parameter, based on the indication. This may comprise, for example, decreasing a duration of a reconfiguration timer configured for the wireless device, or increasing a maximum number of LBT attempts configured for the wireless device for use in determining persistent LBT failure.

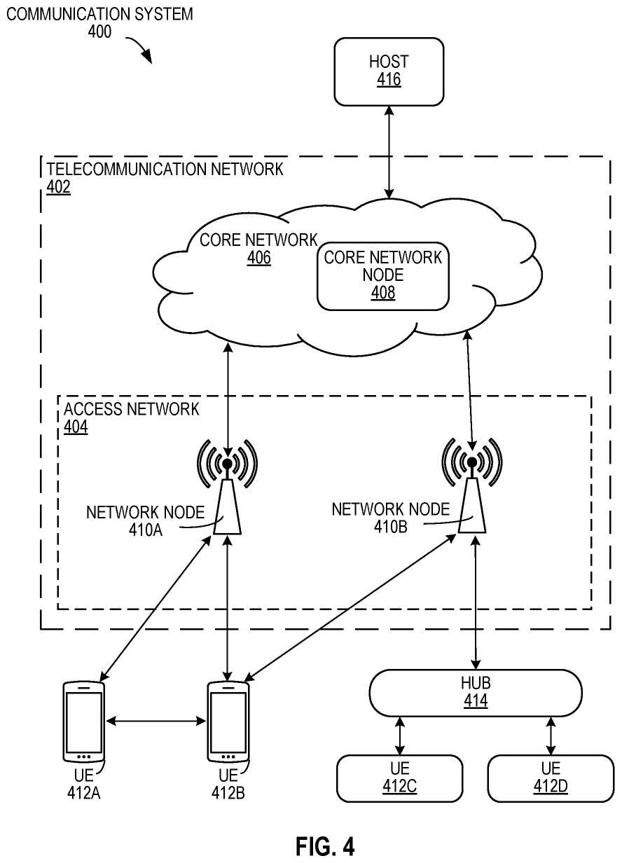

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3rd Generation Partnership Project (3GPP) access node or non-3GPP access point. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WEAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

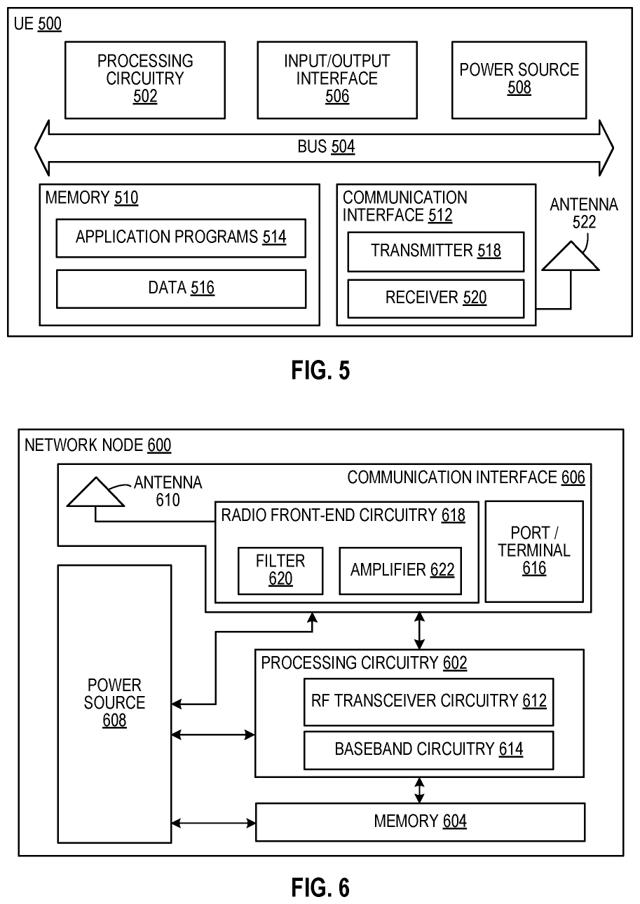

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O & M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

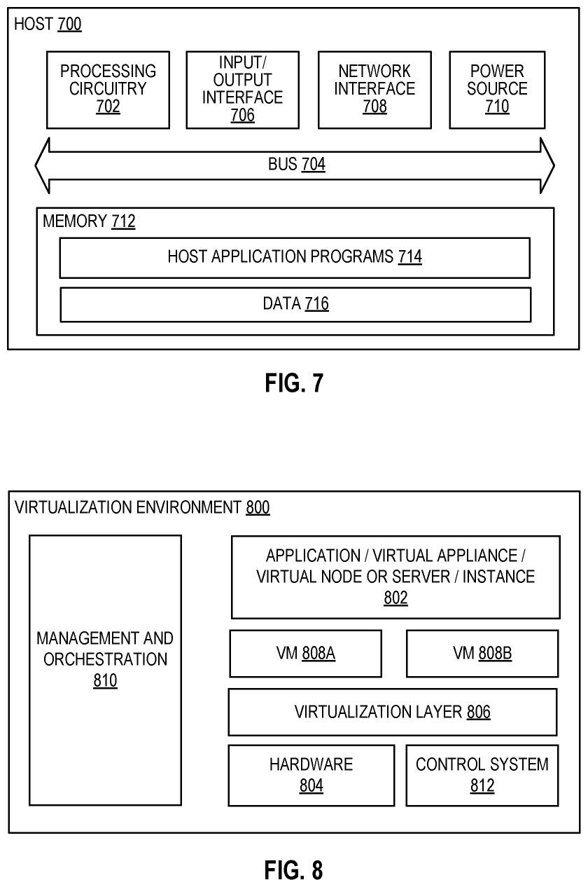

FIG. 7 is a block diagram of a host 700, which may be an embodiment of the host 416 of FIG. 4, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (WC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

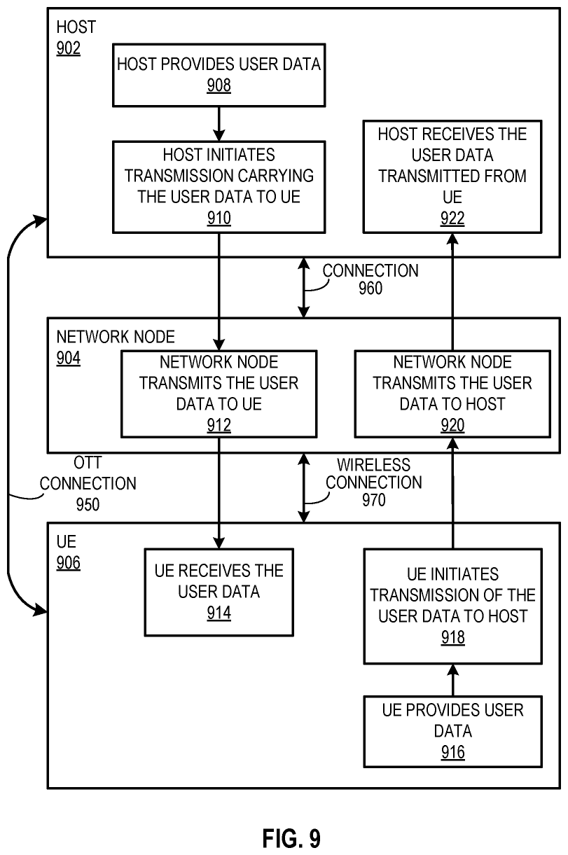

FIG. 9 shows a communication diagram of a host 902 communicating via a network node 904 with a UE 906 over a partially wireless connection in accordance with some embodiments.

Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 9.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve network performance and in particular reduce the number of handover failures and/or improve the ability of the wireless device to recover from such handover failures and thereby provide benefits such as improved reliability and data throughput.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

Embodiments of the techniques, apparatuses, and systems described herein include, but are not limited to, the following enumerated examples:
1. A method in a wireless device for reporting handover failure, HOF, in a wireless network, the method comprising:
   determining that a HOF has occurred in connection with a reconfiguration of at least one connection of the wireless device to the wireless network; and
   sending, to the wireless network, one or more messages reporting the HOF, the one or more messages comprising one or both of (a) an indication of at least one listen-before-talk, LBT, failure experienced by the wireless device in connection with the reconfiguration or (b) an indication of a random access problem experienced by the wireless device in connection with the reconfiguration.
2. The method of example embodiment 1, wherein said determining that a HOF has occurred comprises detecting expiry of a reconfiguration timer.
3. The method of example embodiment 2, wherein the one or more messages further indicate expiry of the reconfiguration timer as a cause of the HOF.
4. The method of any one of example embodiments 1-3, wherein the one or more messages comprise a cause indication indicating random access problem as a cause of the HOF.
5. The method of any one of example embodiments 1-4, wherein the one or more messages comprise a cause indication indicating LBT failure as a cause of the HOF.
6. The method of any one of example embodiments 1-4, wherein the one or more messages comprise a flag indicating that at least one LBT failure was experienced by the wireless device in connection with the reconfiguration.
7. The method of any one of example embodiments 1-4, wherein the one or more messages comprise a flag indicating that at least a predetermined minimum number of LBT failures were experienced by the wireless device in connection with the reconfiguration.
8. The method of any of example embodiments 1-7, wherein the one or more messages identify at least one uplink bandwidth part, UL BWP, in which at least one LBT failure was experienced by the wireless device.
9. The method of any of example embodiments 1-8, wherein the one or more messages indicate an uplink message for which at least one LBT failure was experienced by the wireless device.
10. The method of any of example embodiments 1-9, wherein the one or more messages comprise, for each of one or more random access attempts associated with the RLF, an indication of whether the respective random access attempt suffered an LBT failure in transmitting a random access message.
11. The method of example embodiment 10, wherein the one or more messages further comprise an identifier of an uplink bandwidth part or an identifier of an uplink bandwidth part configuration.
12. The method of example embodiment 10, wherein the one or more messages further comprise an indication of uplink resources associated with each of at least one of the random access attempts.
13. The method of any of example embodiments 10-12, wherein the one or more messages further comprise a threshold number of LBT failures used by the wireless device to determine a consistent LBT failure.
14. A method for optimizing network performance, in a wireless network, the method comprising:
   receiving a report of a handover failure, HOF, experienced by a wireless device in connection with a reconfiguration of at least one connection of the wireless device to the wireless network, the report comprising one or both of (a) an indication of at least one listen-before-talk, LBT, failure experienced by the wireless device in connection with the reconfiguration or (b) an indication of a random access problem experienced by the wireless device in connection with the reconfiguration; and
   performing one or more network optimization tasks, based on the indication.
15. The method of example embodiment 14, wherein the report further indicates expiry of a reconfiguration timer as a cause of the HOF.
16. The method of example embodiment 14 or 15, wherein the report comprises a cause indication indicating random access problem as a cause of the HOF.
17. The method of any one of example embodiments 14-16, wherein the report comprises a cause indication indicating LBT failure as a cause of the HOF.
18. The method of any one of example embodiments 14-16, wherein the report comprises a flag indicating that at least one LBT failure was experienced by the wireless device in connection with the reconfiguration.
19. The method of any one of example embodiments 14-16, wherein the report comprises a flag indicating that at least a predetermined minimum number of LBT failures were experienced by the wireless device in connection with the reconfiguration.
20. The method of any one of example embodiments 14-19, wherein the report identifies at least one uplink bandwidth part, UL BWP, in which at least one LBT failure was experienced by the wireless device.
21. The method of any one of example embodiments 14-20, wherein the report indicates an uplink message for which at least one LBT failure was experienced by the wireless device.
22. The method of any one of example embodiments 14-21, wherein the report comprises, for each of one or more random access attempts associated with the RLF, an indication of whether the respective random access attempt suffered an LBT failure in transmitting a random access message.
23. The method of example embodiment 22, wherein the report further comprises an identifier of an uplink bandwidth part or an identifier of an uplink bandwidth part configuration.
24. The method of example embodiment 22, wherein the report further comprises an indication of uplink resources associated with each of at least one of the random access attempts.
25. The method of any one of example embodiments 22-24, wherein the report further comprises a threshold number of LBT failures used by the wireless device to determine a consistent LBT failure.
26. The method of any one of example embodiments 14-25, wherein said performing one or more network optimization tasks comprises tuning a network parameter, based on the indication.
27. The method of example embodiment 26, wherein tuning the network parameter comprises:
   decreasing a duration of a reconfiguration timer configured for the wireless device; or
   increasing a maximum number of LBT attempts configured for the wireless device for use in determining persistent LBT failure.
28. A wireless device, comprising:
radio circuitry configured to communicate with a wireless network; and
processing circuitry operatively coupled to the radio circuitry and configured to:
   determine that a handover failure, HOF, has occurred in connection with a reconfiguration of at least one connection of the wireless device to the wireless network; and
   send, to the wireless network, one or more messages reporting the HOF, the one or more messages comprising one or both of (a) an indication of at least one listen-before-talk, LBT, failure experienced by the wireless device in connection with the reconfiguration or (b) an indication of a random access problem experienced by the wireless device in connection with the reconfiguration.
29. The wireless device of example embodiment 28, wherein the processing circuitry is configured to determine that a HOF has occurred by detecting expiry of a reconfiguration timer.
30. The wireless device of example embodiment 29, wherein the one or more messages further indicate expiry of the reconfiguration timer as a cause of the HOF.
31. The wireless device of any one of example embodiments 28-30, wherein the one or more messages comprise a cause indication indicating random access problem as a cause of the HOF.
32. The wireless device of any one of example embodiments 28-31, wherein the one or more messages comprise a cause indication indicating LBT failure as a cause of the HOF.
33. The wireless device of any one of example embodiments 28-31, wherein the one or more messages comprise a flag indicating that at least one LBT failure was experienced by the wireless device in connection with the reconfiguration.
34. The wireless device of any one of example embodiments 28-31, wherein the one or more messages comprise a flag indicating that at least a predetermined minimum number of LBT failures were experienced by the wireless device in connection with the reconfiguration.
35. The wireless device of any of example embodiments 28-34, wherein the one or more messages identify at least one uplink bandwidth part, UL BWP, in which at least one LBT failure was experienced by the wireless device.
36. The wireless device of any of example embodiments 28-35, wherein the one or more messages indicate an uplink message for which at least one LBT failure was experienced by the wireless device.
37. The wireless device of any of example embodiments 28-36, wherein the one or more messages comprise, for each of one or more random access attempts associated with the RLF, an indication of whether the respective random access attempt suffered an LBT failure in transmitting a random access message.
38. The wireless device of example embodiment 37, wherein the one or more messages further comprise an identifier of an uplink bandwidth part or an identifier of an uplink bandwidth part configuration.
39. The wireless device of example embodiment 37, wherein the one or more messages further comprise an indication of uplink resources associated with each of at least one of the random access attempts.
40. The wireless device of any of example embodiments 37-39, wherein the one or more messages further comprise a threshold number of LBT failures used by the wireless device to determine a consistent LBT failure.
41. A network node, comprising:
radio circuitry configured to communicate with one or more wireless devices; and
processing circuitry operatively coupled to the radio circuitry and configured to:
   receive a report of a handover failure, HOF, experienced by a wireless device in connection with a reconfiguration of at least one connection of the wireless device to the wireless network, the report comprising one or both of (a) an indication of at least one listen-before-talk, LBT, failure experienced by the wireless device in connection with the reconfiguration or (b) an indication of a random access problem experienced by the wireless device in connection with the reconfiguration; and
   perform one or more network optimization tasks, based on the indication.
42. The network node of example embodiment 41, wherein the report further indicates expiry of a reconfiguration timer as a cause of the HOF.
43. The network node of example embodiment 41 or 42, wherein the report comprises a cause indication indicating random access problem as a cause of the HOF.
44. The network node of any one of example embodiments 41-43, wherein the report comprises a cause indication indicating LBT failure as a cause of the HOF.
45. The network node of any one of example embodiments 41-43, wherein the report comprises a flag indicating that at least one LBT failure was experienced by the wireless device in connection with the reconfiguration.
46. The network node of any one of example embodiments 41-43, wherein the report comprises a flag indicating that at least a predetermined minimum number of LBT failures were experienced by the wireless device in connection with the reconfiguration.
47. The network node of any one of example embodiments 41-46, wherein the report identifies at least one uplink bandwidth part, UL BWP, in which at least one LBT failure was experienced by the wireless device.
48. The network node of any one of example embodiments 41-47, wherein the report indicates an uplink message for which at least one LBT failure was experienced by the wireless device.
49. The network node of any one of example embodiments 41-48, wherein the report comprises, for each of one or more random access attempts associated with the RLF, an indication of whether the respective random access attempt suffered an LBT failure in transmitting a random access message.
50. The network node of example embodiment 49, wherein the report further comprises an identifier of an uplink bandwidth part or an identifier of an uplink bandwidth part configuration.
51. The network node of example embodiment 49, wherein the report further comprises an indication of uplink resources associated with each of at least one of the random access attempts.
52. The network node of any one of example embodiments 22-51, wherein the report further comprises a threshold number of LBT failures used by the wireless device to determine a consistent LBT failure.
53. The network node of any one of example embodiments 41-52, wherein the one or more network optimization tasks comprise tuning a network parameter, based on the indication.
54. The network node of example embodiment 53, wherein tuning the network parameter comprises:
   decreasing a duration of a reconfiguration timer configured for the wireless device; or
   increasing a maximum number of LBT attempts configured for the wireless device for use in determining persistent LBT failure.
56. A wireless device adapted to carry out a method according to any of example embodiments 1-13.
57. A network node adapted to carry out a method according to any of example embodiments 14-27.
58. A computer program product comprising computer program instructions for execution on a processor, the computer program instructions being configured to cause the processor to carry out a method according to any of example embodiments 1-27.
59. A computer-readable medium comprising the computer program product of example embodiment 58.

### Abbreviations

| Abbreviation | Explanation |
|---|---|
| ANR | Automatic Neighbour Relation |
| BWP | Bandwith Part |
| C-RNTI | Cell-Radio Network Temporary Identifier |
| CIO | Cell Individual Offset |
| DL | Downlink |
| DRB | Data Radio Bearer |
| eNB | evolved NodeB |
| gNB | gNodeB |
| HO | Handover |
| HOF | Handover Failure |
| IE | Information Element |
| LBT | Listen-Before-Talk |
| LTE | Long Term Evolution |
| MHI | Mobility History Report |
| MCG | Master Cell Group |
| MRO | Mobility Robustness Optimization |
| NGMN | Next Generation Mobile Networks |
| NR | New Radio |
| PCell | Primary cell |
| PCI | Physical Cell ID |
| QCI | Quality of Service Class Identifier |
| RA | Random Access |
| RACH | Random Access CHannel |
| RAN | Radio Access Network |
| RAT | Radio Access Technology |
| RF | Radio Frequency |
| RLF | Radio Link Failure |
| RRC | Radio Resource Control |
| RSRP | Reference Signal Received Power |
| RSRQ | Reference Signal Received Quality |
| RSSI | Received Signal Strength Indicator |
| SON | Self-Organizing Network |
| UE | User Equipment |
| UL | Uplink |

1-35. (canceled)

36. A method in a wireless device for reporting handover failure (HOF) in a wireless network, the method comprising:
determining that a HOF has occurred in connection with a reconfiguration of at least one connection of the wireless device to the wireless network; and
sending, to the wireless network, one or more messages reporting the HOF, the one or more messages comprising one or both of (a) an indication of at least one listen-before-talk (LBT) failure experienced by the wireless device in connection with the reconfiguration or (b) an indication of a random access problem experienced by the wireless device in connection with the reconfiguration.

37. The method of claim 36, wherein said determining that a HOF has occurred comprises detecting expiry of a reconfiguration timer.

38. The method of claim 37, wherein the one or more messages further indicate expiry of the reconfiguration timer as a cause of the HOF.

39. The method of claim 36, wherein the one or more messages comprise a cause indication indicating random access problem as a cause of the HOF.

40. The method of claim 36, wherein the one or more messages comprise a cause indication indicating LBT failure as a cause of the HOF.

41. The method of claim 36, wherein the one or more messages comprise a flag indicating that at least one LBT failure was experienced by the wireless device in connection with the reconfiguration.

42. The method of claim 36, wherein the one or more messages comprise a flag indicating that at least a predetermined minimum number of LBT failures were experienced by the wireless device in connection with the reconfiguration.

43. The method of claim 36, wherein the one or more messages identify at least one uplink bandwidth part (UL BWP) in which at least one LBT failure was experienced by the wireless device.

44. The method of claim 36, wherein the one or more messages indicate an uplink message for which at least one LBT failure was experienced by the wireless device.

45. The method of claim 36, wherein the one or more messages comprise, for each of one or more random access attempts associated with the RLF, an indication of whether the respective random access attempt suffered an LBT failure in transmitting a random access message.

46. The method of claim 45, wherein the one or more messages further comprise an identifier of an uplink bandwidth part or an identifier of an uplink bandwidth part configuration.

47. The method of claim 45, wherein the one or more messages further comprise an indication of uplink resources associated with each of at least one of the random access attempts.

48. The method of claim 45, wherein the one or more messages further comprise a threshold number of LBT failures used by the wireless device to determine a consistent LBT failure.

49. A non-transitory computer-readable medium comprising, stored thereupon, a computer program product comprising computer program instructions for execution on a processor, the computer program instructions being configured to cause the processor to carry out a method according to claim 36.

50. A method for optimizing network performance, in a wireless network, the method comprising:
receiving a report of a handover failure (HOF) experienced by a wireless device in connection with a reconfiguration of at least one connection of the wireless device to the wireless network, the report comprising one or both of (a) an indication of at least one listen-before-talk (LBT) failure experienced by the wireless device in connection with the reconfiguration or (b) an indication of a random access problem experienced by the wireless device in connection with the reconfiguration; and
performing one or more network optimization tasks, based on the indication.

51. The method of claim 50, wherein the report further indicates expiry of a reconfiguration timer as a cause of the HOF.

52. The method of claim 50, wherein the report comprises a cause indication indicating random access problem as a cause of the HOF.

53. The method of claim 50, wherein the report comprises a cause indication indicating LBT failure as a cause of the HOF.

54. The method of claim 50, wherein the report comprises a flag indicating that at least one LBT failure was experienced by the wireless device in connection with the reconfiguration.

55. The method of claim 50, wherein the report comprises a flag indicating that at least a predetermined minimum number of LBT failures were experienced by the wireless device in connection with the reconfiguration.

56. The method of claim 50, wherein the report identifies at least one uplink bandwidth part (UL BWP) in which at least one LBT failure was experienced by the wireless device.

57. A non-transitory computer-readable medium comprising, stored thereupon, a computer program product comprising computer program instructions for execution on a processor, the computer program instructions being configured to cause the processor to carry out a method according to claim 50.

58. A wireless device, comprising:
radio circuitry configured to communicate with a wireless network; and
processing circuitry operatively coupled to the radio circuitry and configured to:
determine that a handover failure (HOF) has occurred in connection with a reconfiguration of at least one connection of the wireless device to the wireless network; and
send, to the wireless network, one or more messages reporting the HOF, the one or more messages comprising one or both of (a) an indication of at least one listen-before-talk (LBT) failure experienced by the wireless device in connection with the reconfiguration or (b) an indication of a random access problem experienced by the wireless device in connection with the reconfiguration.

59. A network node, comprising:
radio circuitry configured to communicate with one or more wireless devices; and
processing circuitry operatively coupled to the radio circuitry and configured to:
receive a report of a handover failure (HOF) experienced by a wireless device in connection with a reconfiguration of at least one connection of the wireless device to the wireless network, the report comprising one or both of (a) an indication of at least one listen-before-talk (LBT) failure experienced by the wireless device in connection with the reconfiguration or (b) an indication of a random access problem experienced by the wireless device in connection with the reconfiguration; and
perform one or more network optimization tasks, based on the indication.
